(19) United States
(12) Patent Application Publication
(10) Pub. No.: US 2026/0339919 A1
(43) Pub. Date: Oct. 29, 2026

(54) ANOMALY DETECTION IN DIGITAL DOCUMENTS

(71) Applicants: American Express Travel Related Services Company, Inc., New York, NY (US); American Express International Inc., One Marina Boulevard (SG)

(72) Inventors: Radhakrishnan Gopalakrishnan, Gurgaon (IN); Vamsi Praveen Konjeti, Chennai (IN); Archit Jain, Ghaziabad (IN); Rosalind Ai Ling Poh, Singapore (SG)

(21) Appl. No.: 19/191,929

(22) Filed: Apr. 28, 2025

(51) Int. Cl. G06F 16/23; G06F 16/93

(52) U.S. Cl. CPC G06F 16/2365; G06F 16/93

(57) ABSTRACT

A plurality of digital documents is received with a software application. A digital document in the plurality of digital documents that includes an anomaly is identified by executing an artificial intelligence (AI) model on the plurality of digital documents, wherein the AI model is configured to identify anomalous values in digital documents based on historical values in historical digital documents. The digital document is removed from the plurality of digital documents to generate a reduced set of digital documents. A second AI model is executed on the reduced set to generate a determination. The anomaly is corrected using the software application based on the determination.

### BACKGROUND

Analyzing digital documents such as tax documents, financial statements, and the like, typically involves deciphering a myriad of intricate data points. In some cases, a company may need to manipulate such documents but may encounter human errors, for example when inputting values into the documents. These manipulations may create anomalies within the documents that may be undetected or may be detected when reviewed by an individual with proficient knowledge. However, it is not efficient, or in many cases not possible, to manually review all documents for anomalies.

### SUMMARY

One example embodiment provides an apparatus that may include a memory and at least one processor communicatively coupled to the memory, where the at least one processor is configured to perform one or more of training at least one artificial intelligence (AI) model to identify anomalous values in digital documents based on historical values that are stored in historical digital documents, receiving a plurality of digital documents with a software application, identifying at least one digital document among the plurality of digital documents which includes an anomaly based on execution of the at least one trained AI model on the plurality of digital documents, removing the at least one digital document from the plurality of digital documents to generate a reduced set of digital documents, and executing a second AI model on the reduced set of digital documents to generate a determination, and executing a function within the software application based on the determination.

Another example embodiment provides a method that includes one or more of training at least one AI model to identify anomalous values in digital documents based on historical values that are stored in historical digital documents, receiving a plurality of digital documents with a software application, identifying at least one digital document among the plurality of digital documents which includes an anomaly based on execution of the at least one trained AI model on the plurality of digital documents, removing the at least one digital document from the plurality of digital documents to generate a reduced set of digital documents, executing a second AI model on the reduced set of digital documents to generate a determination, and executing a function within the software application based on the determination.

A further example embodiment provides a computer-readable storage medium that contains program instructions which when executed by at least one processor cause the at least one processor to perform one or more of training at least one AI model to identify anomalous values in digital documents based on historical values that are stored in historical digital documents, receiving a plurality of digital documents with a software application, identifying at least one digital document among the plurality of digital documents which includes an anomaly based on execution of the at least one trained AI model on the plurality of digital documents, removing the at least one digital document from the plurality of digital documents to generated a reduced set of digital documents, executing a second AI model on the reduced set of digital documents to generate a determination, and executing a function within the software application based on the determination.

### BRIEF DESCRIPTION OF THE DRAWINGS

FIG. 1 is a diagram illustrating a computing environment for detecting anomalies in digital documents according to an embodiment of the instant solution.

FIG. 2 is a diagram illustrating a process of designing and training an AI model according to an embodiment of the instant solution.

FIG. 3A is a diagram illustrating a process of removing documents with anomalies from a set of digital documents prior to inputting the set of digital documents to a downstream system according to an embodiment of the instant solution.

FIG. 3B is a diagram illustrating a process of determining whether a value is an anomaly based on thresholds according to an embodiment of the instant solution.

FIG. 4 is a diagram illustrating an example of an isolation forest model according to an embodiment of the instant solution.

FIG. 5A is a diagram illustrating a process of querying a user to correct an anomalous value in a digital document according to an embodiment of the instant solution.

FIG. 5B is a diagram illustrating a process of autocorrecting an anomalous value in a digital document according to an embodiment of the instant solution.

FIG. 6A is a flow diagram illustrating a method according to an embodiment of the instant solution.

FIG. 6B is a flow diagram illustrating a method according to an embodiment of the instant solution.

FIG. 7 is a diagram illustrating a computing system for use with the examples described herein according to an embodiment of the instant solution.

### DETAILED DESCRIPTION

It is to be understood that although this disclosure includes a detailed description of cloud computing, implementation of the teachings recited herein is not limited to a cloud computing environment. Rather, embodiments of the instant solution are capable of being implemented in conjunction with any other type of computing environment now known or later developed.

The example embodiments are directed to an artificial intelligence (AI) system that can analyze the content of digital documents that are uploaded to a platform, such as tax documents, financial statements, balance sheets, income statements, statements of cash flow, statements of retained earnings, corporate documents, business documents, and the like, and identify if the digital documents contain anomalous values. Each document may contain a predefined set of fields that are dedicated to storing values for various attributes (e.g., income, expenses, taxes paid, profits, losses, etc.) and detecting when one or more of these values appears to be incorrect (e.g., an anomaly) based on previous/historical statements, similar statements from other entities, and the like.

In some embodiments, the AI system may include multiple AI models with an AI model in the system directed to identifying documents with anomalies and removing those documents from a larger set of documents. The reduced set of documents may then be input to one or more additional downstream AI models that are capable of performing additional tasks such as determining credit decisions, determining tax liabilities, generating expense reports, and the like. The AI system may use one or more of the AI models to correct any anomalies within a document. For example, the AI system may prompt a user for additional input via natural language queries. As another example, the AI system may attempt to auto correct any anomalies using other documents that the system has already ingested or can access.

As an example, anomaly detection may be performed to detect outliers in data contained in a digital document, web page, mobile application, and the like. For example, the system may determine standard deviations of the data using a rolling window of the data values, perform analysis (such as cluster analysis, auto-Arima analysis, etc.) on the data (which may be time-series data) to determine whether a data value (which may be existing or new) is an outlier or not. This action may involve multiple decisions being generated by the instant solution. For a value in the document (such as “profit”), the AI system may determine an upper threshold and a lower threshold for the value that is within normal boundaries. Any value outside of these thresholds may be considered an anomaly. Therefore, the instant AI system can quickly determine whether a value within the digital document is an anomaly by comparing the value to both the upper threshold and the lower threshold. If the value is below the upper threshold and above the lower threshold, it may not be considered an anomaly. However, if the value is above the upper threshold or below the lower threshold, it may be considered an anomaly.

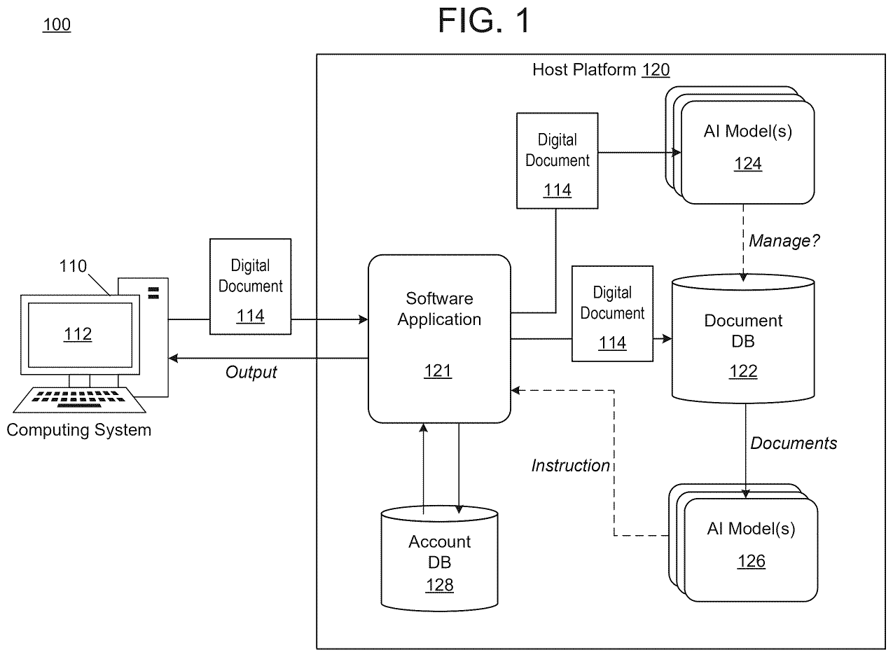

FIG. 1 illustrates a computing environment 100 that is configured to detect anomalies in digital documents according to an embodiment of the instant solution. In this example, a software application 121 may analyze content within a digital document, detect anomalies, remove the document from a larger set of documents, auto-correct the document (and/or receive corrective action from another system or user), and the like. The software application 121 may contain or may otherwise be communicatively coupled to artificial intelligence (AI) models including at least one AI or Machine Learning (ML) model 124 that is configured to detect anomalies in documents, and at least one additional AI or ML model 126 that is configured to perform downstream processing on the document content, for example, for making decisions such as those related to a potential credit limit increase, a loan approval, a new account approval, a security review, a tax preparation, or the like.

Referring to FIG. 1, a computing system 110, for example, a desktop computer, a laptop computer, a mobile device, or the like, may connect to a host platform 120 over a network such as the Internet, a private computer network, or the like, and via a wired or wireless connection. The host platform 120 may host the software application 121. The host platform 120 may include a cloud platform, a web server, a database, a distributed system, a combination of systems, and the like.

According to various embodiments, the computing system 110 may send a digital document 114 to the software application 121 hosted by the host platform 120 through the network. The digital document 114 may consist of a structured format with predefined fields for storing values of various attribute of a company, person, or the like. The digital document 114 may be stored within a document database 122 that may be included on the host platform 120. For example, the digital document 114 may be stored with a set or group of digital documents that are related to the same (or similar) entity, the same (or similar) topic, or the like.

A copy of the digital document 114 may also be transferred to the at least one AI model 124 which is configured to detect if any anomalies (e.g., outliers, etc.) are stored within the digital document 114. For example, the at least one AI model 124 may be trained to detect anomalies by executing the at least one AI model 124 on historical document content and patterns of data identified by the at least one AI model during a learning process (e.g., unsupervised learning, etc.) which may consist of patterns of anomalous values and non-anomalous values. In some embodiments, the at least one AI model 124 may be retrained based on feedback from the user and/or feedback that is captured automatically from the system, environment, etc. The retraining enables the at least one AI model to evolve based on the evolution of different anomalies.

The at least one AI model 124 may detect whether the digital document 114 includes any anomalies, and may notify the software application 121, the document database 122, at least one additional AI or ML model(s) 126, and the like. For example, the at least one AI model 124 may trigger the document database 122 or the software application 121 to remove the digital document 114 from a larger set or group of digital documents, due to one or more anomaly.

As another example, the software application 121 and/or the at least one additional AI model 126 may request correction of the anomalous value(s) via the computing system 110. For example, a question or other natural language message may be displayed on a display device 112 of the computing system 110. The software application 121 may include a graphical user interface (GUI) that is accessible to the computing system 110 through a web browser of the computing system 110. The GUI may display the query or question and receive a response (from a user, from another system, etc.) and transmit the response back to the software application 121. In response, the software application 121 can pass the new value to the at least one AI model 124 to determine if the new value is an anomaly or non-anomaly. If it is a non-anomaly, the software application 121 may modify or update the digital document 114 with the new value, and store the updated digital document 114 within the document database 122. The set of documents that is input to the at least one additional AI model 126 may include the digital document 114 that has been corrected.

As another example, the software application 121 may use an identifier of a field within the digital document 114 (e.g., a unique number, value, etc.) that is assigned to the field that includes the anomaly, and attempt to auto-correct the anomaly. For example, the software application 121 may search for similar fields in other documents that are stored within the document database 122 or another database communicatively coupled to the host platform 120. If another document is found with a different value for the same field, the different value can be extracted and analyzed by the at least one AI model 124. If the different value from the different document is non-anomalous, the different value can be added to the digital document and used to update or auto-correct it. In some embodiments, the software application 121 may ask for confirmation of the auto-correction via the GUI on the display device 112 of the computing system 110, and may not update the digital document until confirmation is received.

In some embodiments, the anomaly within the digital document 114 may create a risk or issue associated with the user of the computing system 110. The software application 121 may modify features, settings, parameters, functionality, behavioral capabilities, and the like, of an account, software, mobile application, etc. of the user on the computing system 110 or another computing system (not shown) such as a mobile device. For example, the software application 121 may prevent the user from performing various communications, messaging behaviors, updates to account data, conduct transactions above certain amounts, and the like. The software application 121 may make such changes by modifying settings or software within an account database 128.

In some embodiments, the at least one AI model 124 may learn anomalous thresholds (e.g., maximum threshold, minimum threshold, etc.) which identify normal/typical values for the data and outliers/atypical values. When a data attribute within a document contains a value that exceeds the maximum threshold or falls below the minimum threshold, the data attribute may be determined to contain an anomaly. Examples of anomalies include data values that are outside of a maximum and minimum threshold for the data values.

The thresholds for anomaly detection (data points that are outliers in the data) can be determined by the at least one AI model 124 from its training, for example, based on historical data that may be analyzed using a rolling window (e.g., the previous month, the previous two months, the previous six months, the previous year, etc.) This enables the anomaly detection process to adapt/evolve over time as the data evolves. The training may result in model parameters being generated and stored within a software library that is used by the at least one AI model 124 during inference.

In this example, the computing system 110 may include the display device 112 which displays a GUI of the software application 121. In some embodiments, the user may enter commands into the GUI via the computing system 110 (e.g., via an input mechanism such as a keyboard, mouse, touching the display device 112, etc.). The GUI may include control elements such as input fields, buttons, sliders, and the like, which enable a user to input commands via the GUI.

In some embodiments, the software application 121 may include or may be communicatively coupled to at least one additional AI model 126. The software application 121 may call the at least one additional AI model 126 to determine or predict a cause of the anomaly, auto-correct the anomaly, notify the user for a solution to the anomaly, and the like. The determination by the at least one additional AI model 126 may be used by the software application 121 to modify the GUI including changing colors, shading, etc. of display elements within a digital document. For example, when the software application 121 detects an anomaly within the digital document 114, the software application 121 may display the field with a highlight around it or some other visual indicator to change its appearance and distinguish it from other values within the digital document 114 which are not anomalies.

Examples of the AI models 124, 126 may include machine learning models, natural language processing models, generative AI models, neural network models, deep learning models and any future AI models that are yet to be developed possessing characteristics of memory machines (such as limited memory machines, for example).

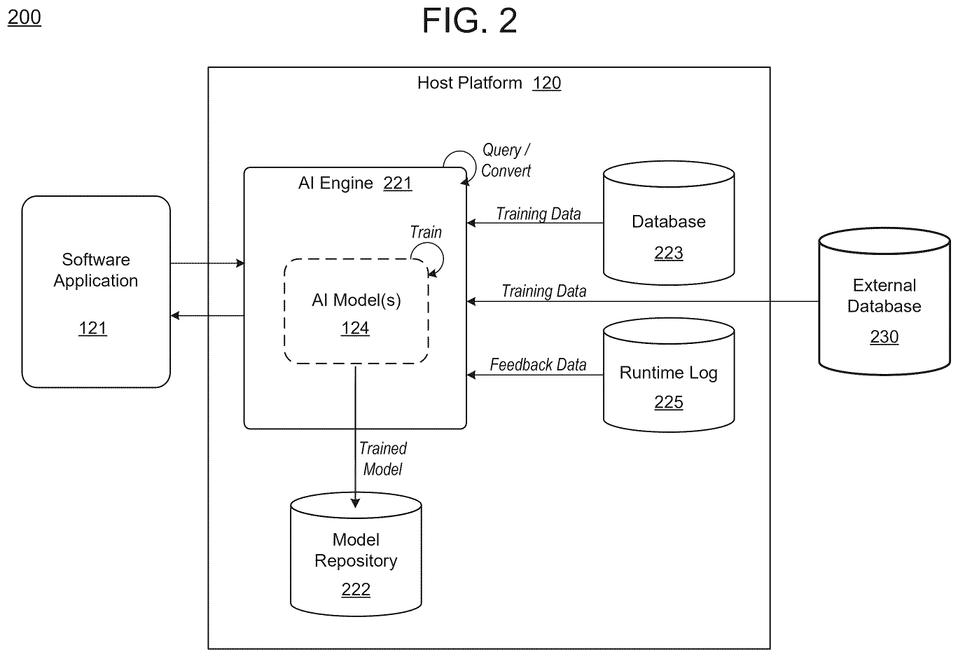

FIG. 2 illustrates a process 200 of designing and training the at least one AI model 124 according to an embodiment of the instant solution. Referring to FIG. 2, the host platform 120 may host the software application 121, which includes access to a training script, service, integrated development environment, etc., and which can be used to train and retrain AI models, machine learning models, and the like. In this example, the software application 121 may include a user interface accessible by a user device (not shown) over a network or through a local connection. For example, the software application 121 may be embodied as a web application that can be accessed at a network address, URL, etc., by a device. As another example, the software application 121 may be locally or remotely installed on a computing device.

The software application 121 may be used to design a model, such as an AI model 224, that can detect anomalies/outliers in digital documents. The model can be executed/trained based on the training data established via the user interface. For example, the user interface may be used to build a new model. The training data for training such a new model may be provided from a training data store such as a database 223 which includes training samples from the Internet, from customers, from private sources, from various data providers, and the like. The training data may include historical digital documents and values (e.g., anomalies, non-anomalies, etc.). The at least one AI model 124 may be trained using supervised or unsupervised learning. For example, during an unsupervised learning process, the at least one AI model 124 may learn patterns from the training data in an automated manner without labelled training data. As another example, the training data may be pulled from one or more external data stores 230 such as publicly available sites, etc. As another example, the training data may include runtime data (e.g., feedback data, etc.) from a runtime log 225. The runtime log 225 may include feedback about the predictions made by the at least one AI model 124 such as indications of whether a predicted anomaly is correct, etc.

During training, the at least one AI model 124 may be executed on training data via an AI engine 221 of the host platform 120. Through the execution, which may be iteratively performed, the at least one AI model 124 may learn how to predict anomalies related to values associated with certain documents. When the model is fully trained, it may be stored within the model repository 222 via the software application 121.

As another example, the software application 121 may be used to retrain the at least one AI model 124 after the model has already been deployed. The retraining process may use executional results that have already been generated/output by the at least one AI model 124 in a live environment (including any user feedback, etc.) to retrain the at least one AI model 124. For example, users may provide feedback in the form of “yes” and “no” to indicate whether the predicted values are correct or not. This data may be captured and stored within the runtime log 225 or other data store within the live environment and can be subsequently used to retrain the at least one AI model 124.

In some embodiments, the AI models described herein may be an isolation forest model which is an unsupervised tree-based learning algorithm that can be used for outlier detection. In the example embodiment, the isolation forest includes multiple trees which are created by random selection of features and split values until all observed predefined values in a digital document are isolated for comparison/anomaly detection. A “split” within a tree structure of the isolation forest may include a first possible path corresponding to an anomaly and a second possible path corresponding to a normal/non-anomaly. These splits may be linked together to create a chain of a plurality of splits corresponding to a plurality of document values that can be checked for anomalies.

In some embodiments, the system may be configured to identify certain types of anomalies withing financial documents. The AI based systems 100, 200 described herein may analyze patterns in financial statements and flag any deviations from established baseline/normal patterns as anomalies or potential errors. The instant solution is highly scalable and can be applied to any financial document across different markets and industries.

According to various embodiments, the system may receive unstructured financial statements from business customers in a specific industry and extract and transform the unstructured financial statements into structured financial statements. As another example, the system may receive financial statements that are already structured. The system may create financial statement attributes and associated attribute values based on the structured financial statements, wherein the financial statement attributes include balance sheet attributes, profit and loss attributes, financial ratio attributes, year-over-year (YoY) change attributes, and triangulation attributes.

The example embodiments may include a process for training and using an industry specific outlier detection model to detect outliers in incoming data such as network data, transaction data, and the like. The training of the model may be performed based on financial statement attributes and associated attribute values created. In some examples, the industry specific outlier detection model is an isolation forest comprising a plurality of isolation trees. The isolation forest may be partitioned into a plurality of trees to determine normal attribute values, anomalous attribute values, and threshold attribute values for each of the plurality of financial statement attributes. The system described herein may receive an unstructured financial statement from a business customer in the specific industry and extract and transform the unstructured financial statement into a structured financial statement. The system may identify at least one anomalous financial statement attribute and an associated reason in the unstructured financial statement using the industry specific outlier detection model.

When a document is detected as containing an anomaly, a decision can be made whether the document should be removed from a larger group of documents, for example, from a group of documents being input to a downstream AI model. The decision of whether to remove the document may be made by the software application described herein. For example, anomalies in certain attribute types may automatically cause a document to be removed. As another example, anomalies that are significant enough in other attribute types may cause the document to be removed, whereas less significant anomalies may not cause the document to be removed. The removal rules may be contained within the logic/source code of the software application that is described herein.

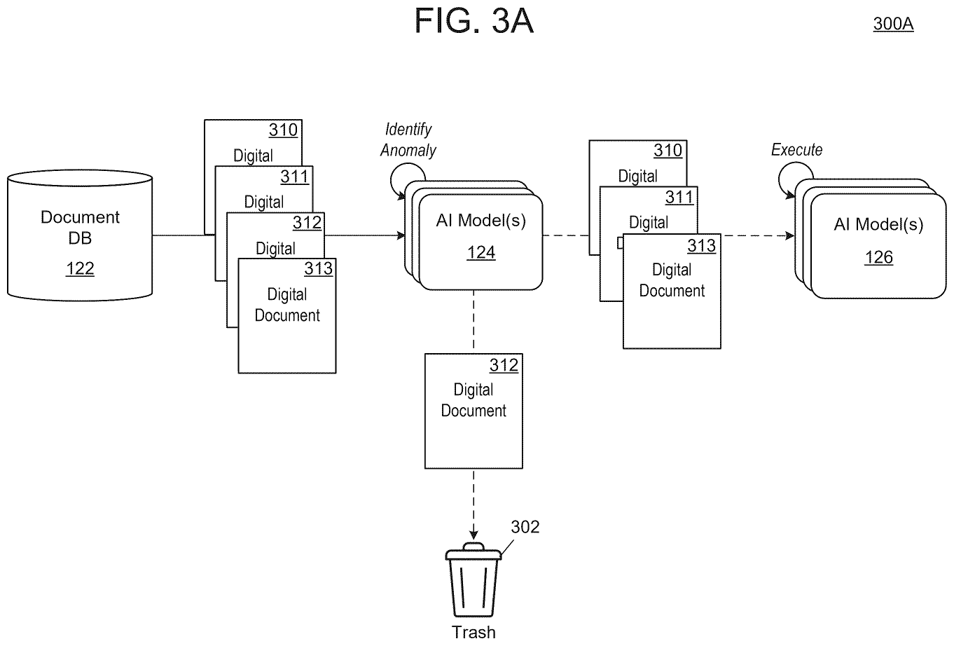

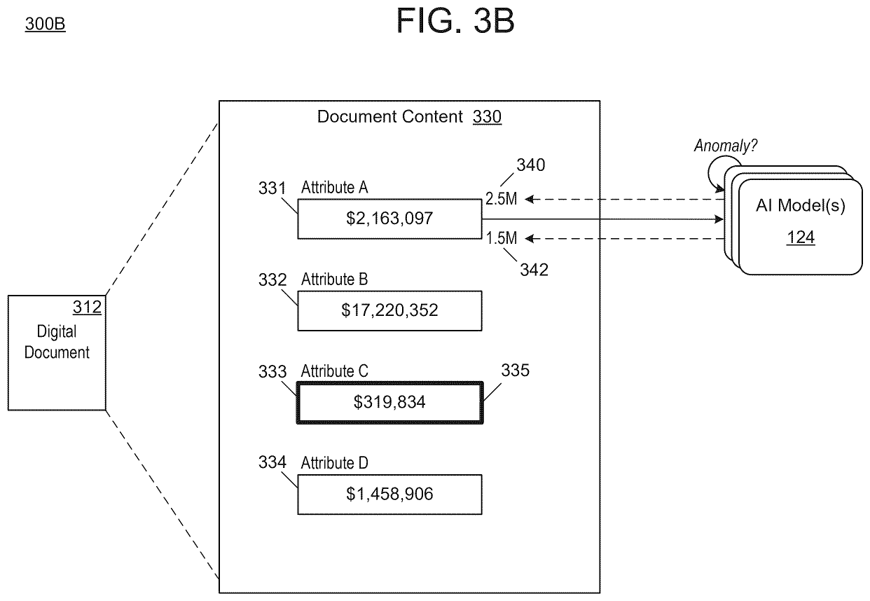

FIG. 3A illustrates a process 300A of removing documents with anomalies from a set of digital documents prior to inputting the set of digital documents to a downstream system according to an embodiment of the instant solution. Referring to FIG. 3A, a set of digital documents 310-313 is transferred from a document database 122 to the at least one AI model 124. Here, the set of digital documents includes a digital document 310, a digital document 311, a digital document 312, and a digital document 313. Each digital document may be related to the other, for example, the document may be from a same company, a same time period, a same type, and the like. The set of digital documents 310-313 may be used for determining if an anomaly exists (for example, whether a potential tax issue exists for a set of digital documents associated with an entity).

In this example, the at least one additional AI model 126 may be configured to determine which values within a tax form are anomalous, and output the values and the corresponding identifiers of fields to which they belong to a display of the software application. Here, the system only wants to use accurate documentation when making the decision on the values. Therefore, the set of digital documents (including the digital document 310, the digital document 311, the digital document 312, and the digital document 313) may be input to the at least one AI model 124 for anomaly detection. In this example, the digital documents may be converted into vectors or other embeddings prior to input to the at least one AI model 124. In response, the at least one AI model 124 may determine if any of the digital documents contain anomalies (anomalous values). In this example, the at least one AI model 124 detects that the digital document 312 contains an anomaly.

A script may execute the at least one AI model 124 and may take an output of a prediction of the anomaly from the at least one AI model 124 and provide the output with the predicted anomaly to the software application 121. In response, the software application 121 may take steps to correct the anomaly. For example, the anomaly may include an income value for a month of the year that does not appear to be correct. The anomaly may be detected by the at least one AI model 124 based on previous income values for the month, previous income values for other months, a predicted income value for the month, and the like. The software application 121 may correct the anomaly by identifying the correct value for income for the month from another document, such as another digital document in the set of digital documents. If the software application 121 is unable to find the answer there, the software application 121 may query other data sources such as websites, databases, account profiles, and the like. As another option, the software application 121 may display a window or other interface on a GUI of the software application 121 which enables a user to enter the correct value for income for the month.

As another example, and as is the case in FIG. 3A, the software application may remove the digital document 312 from the set of digital documents and discard the digital document 312 in a trash bin 302. The software application may then pass the corrected or the remaining set of digital documents (i.e., the digital document 310, the digital document 311, and the digital document 313) to the at least one additional AI model 126 for the tax issue analysis. By removing the digital document 312 from the downstream processing task by the at least one additional AI model 126, the at least one AI model 124 can be used to improve the accuracy of the output of the at least one additional AI model 126. Therefore, the system improves the accuracy of the predictions made thereby.

FIG. 3B illustrates a process 300B of determining whether a value is an anomaly based on thresholds according to an embodiment of the instant solution. For example, the process 300B shown in FIG. 3B may be performed by the at least one AI model 124 for each document included in the set of digital documents shown in FIG. 3A. Referring to FIG. 3B, the digital documents may include document content 330 with a set of attributes with values therein (e.g., values stored in input boxes, unstructured text, etc.) that represent financial information or the like (for example, of an entity). The set of attributes include a first attribute (or Attribute A) 331, a second attribute (or Attribute B) 332, a third attribute (or Attribute C) 333, and a fourth attribute (or Attribute D) 334.

In this example, the at least one AI model 124 may determine an upper threshold 340 and a lower threshold 342 for the first attribute 331 of a digital document. The at least one AI model 124 may then compare an actual value for the first attribute 331 to the upper threshold 340 and the lower threshold 342 to ensure that the actual value falls below the upper threshold 340 and above the lower threshold 342. If it does, then the value is not an anomaly. If, however, the value falls outside of one of the thresholds, it is considered an anomaly. In this example, the value for the first attribute 331 is not an anomaly. However, a value 335 of the third attribute 333 of the document content 330 contains an anomaly as the value, for example, should be below $100,000, but is well above this upper threshold, and is therefore detected as an anomaly.

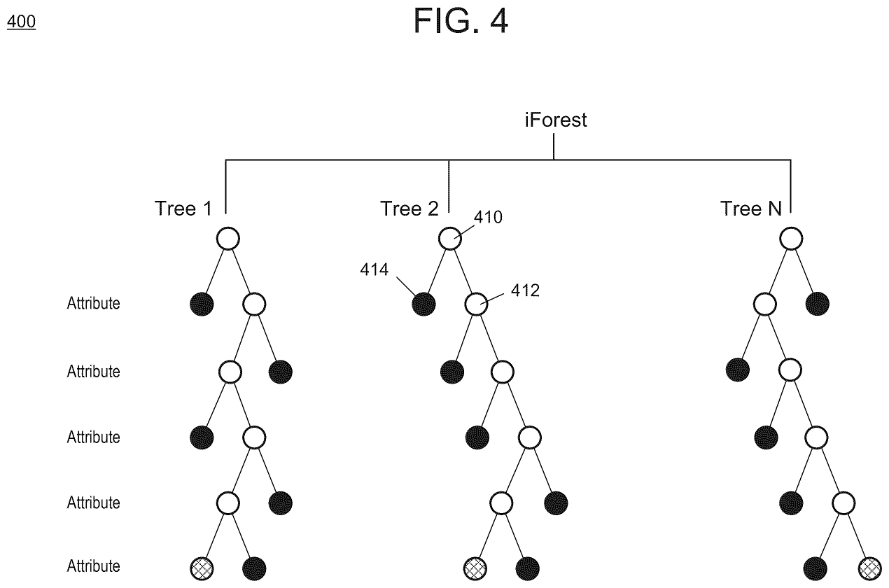

FIG. 4 illustrates a view 400 of an isolation forest model according to an embodiment of the instant solution. Referring to FIG. 4, the isolation forest model includes a plurality of trees, where each tree includes a plurality of splits. Each split may represent an attribute that is included in a digital document and may include a node with two paths/branches therefrom including a first path which terminates (anomaly) and a second path which either continues or terminates (non-anomaly).

In the example of FIG. 4, the number of trees that are used may be randomly determined or determined by the number of attributes in the documents. The trees may verify different attributes of the document. Each tree may include multiple splits representing multiple paths (anomaly versus non-anomaly) for the process to take through the isolation forest. Here, the second tree includes a root node 410. A first decision is made at the root node 410 about a first value/attribute in a digital document. If the value is an anomaly, the model traverses to node 414 where the process terminates due to the detection of the anomaly. As another example, if the value is not an anomaly, the model traverses the tree to node 412 where another attribute value is analyzed by the isolation forest. This process continues until all possible anomalies are checked for, or an anomaly is identified.

In some embodiments, in addition to removing the digital document from downstream processing, or instead, the system may correct the anomaly within the digital document thereby creating an updated digital document. The updated digital document may then be passed to a downstream AI model, or the like. Below are some examples of correcting an anomaly that is found within a digital document.

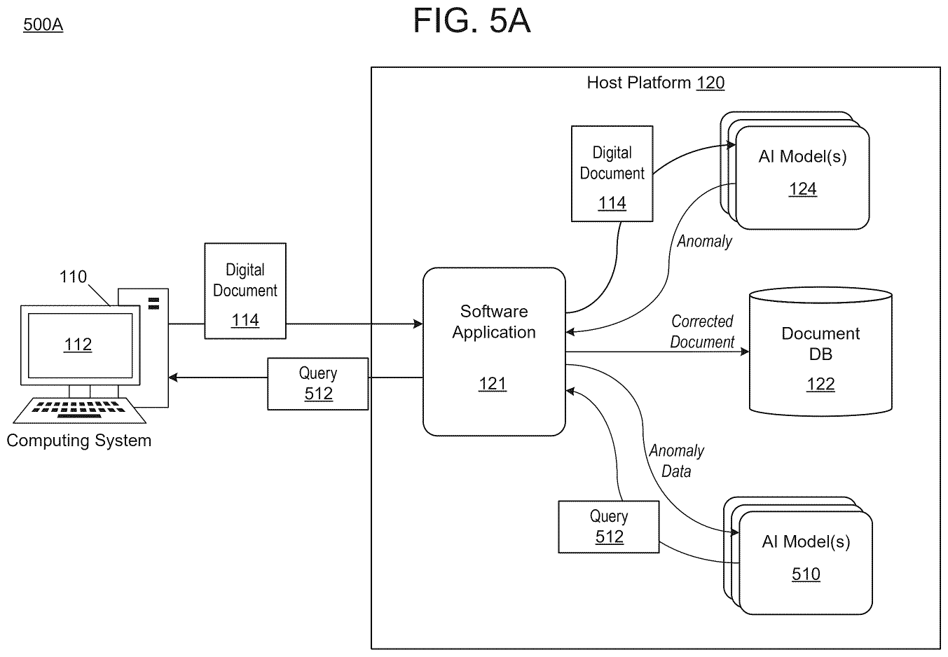

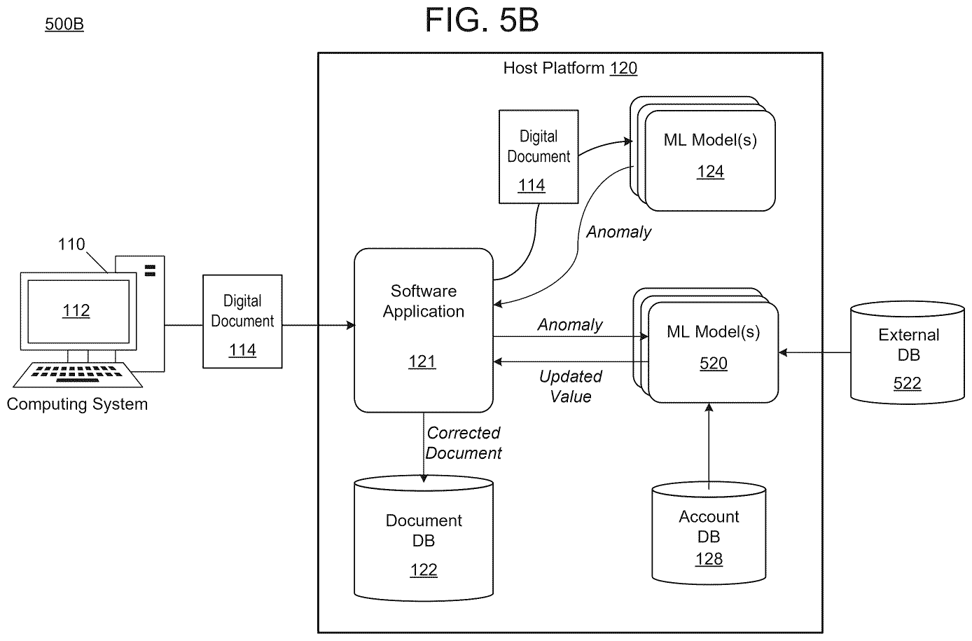

FIG. 5A illustrates a process 500A of querying a user to correct an anomalous value in a digital document according to an embodiment of the instant solution. Referring to FIG. 5A, in this example, a user of the computing system 110 has uploaded the digital document 114 to the software application 121 on the host platform 120. Here, the host platform 120 hosts the at least one AI model 124 that is configured to detect an anomaly within the digital document 114. In response to detecting the anomaly, the at least one AI model 124 notifies the software application 121 of the value, and the attribute, that include the anomaly.

In response, the software application 121 may query at least one additional AI model 510 which can generate a language query/question that can be provided to the user of the computing system 110 or to the computing system directly to correct the anomaly within the digital document 114. For example, the at least one additional AI model 510 may generate a natural language query based on a prompt template and the anomaly from the at least one AI model 124. The prompt template may be generated by the software application 121 and input to the at least one additional AI model 510 when generating the natural language query. The prompt template may include static content with instructions that tell the at least one additional AI model 510 what task to perform.

In response, the at least one additional AI model 510 may generate a natural language query 512 that is provided to the software application 121. The software application 121 may output the natural language query 512 on the display device 112 of the computing system 110. The user may respond with an updated/new value via the display device 112, for example, by inputting new content, values, etc. to a GUI of the software application 121 displayed on the display device 112. The new value may be analyzed by the at least one AI model 124 to determine whether or not it is an anomaly. If it is not an anomaly, the new value may be used by the software application 121 to update the digital document 114 and store the updated digital document within the document database 122.

FIG. 5B illustrates a process 500B of autocorrecting an anomalous value in a digital document according to an embodiment of the instant solution. Referring to FIG. 5B, in this example, the software application 121 receives a notification from the at least one AI model 124 indicating the digital document 114 contains an anomaly for a value of an attribute. In response, the software application 121 may identify related documentation associated with the digital document 114, the entity, etc., and attempt to find a corrected value for the anomalous value.

That is, the software application 121 may look for similar values in other documents stored within the document database 122, an external database 522, an account database 128, and the like. If a different value is found for the same attribute, the software application 121 may attempt to use the different value. The software application 121 may provide it to the at least one AI model 124 to determine if it's an anomaly or not. The software application 121 may also output a request to the display device 112 to confirm use of the found value for the attribute. The software application 121 may update the digital document 114 with the new/found value to generate an updated digital document. The updated digital document may be fed to a downstream AI model.

As another example, the software application 121 may use at least one additional AI model 520 to predict or infer a correct/accurate value for the anomaly. For example, the at least one additional AI model 520 may be trained to predict accurate values based on historical values, trends, patterns, and the like, in historical data. In some embodiments, the at least one additional AI model 520 may use documents from an external database 522, documents from an account database 128 or the like. The inferred data value may be displayed on the display device 112 of the computing system 110 and confirmed by the user before being added to the digital document 114 by the software application 121 to create the updated digital document.

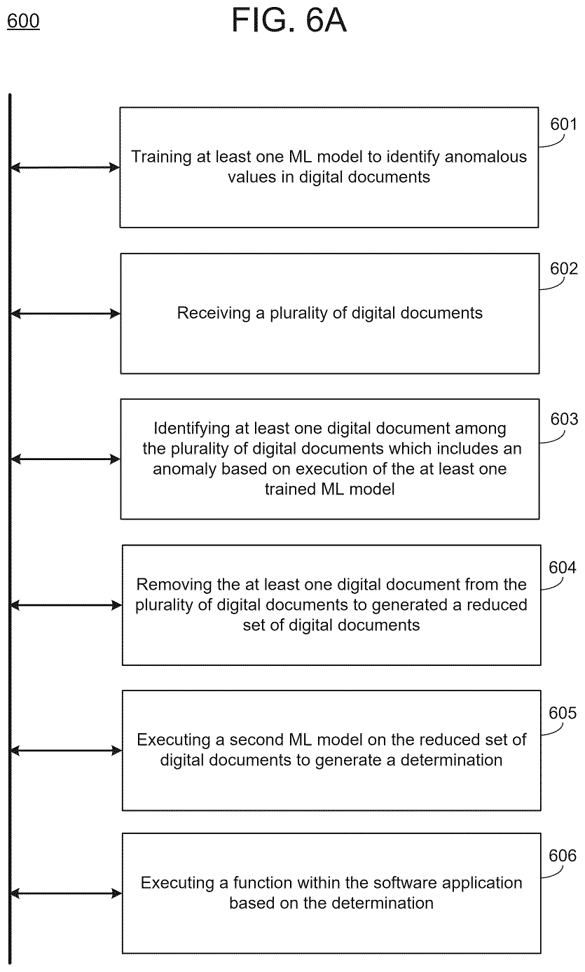

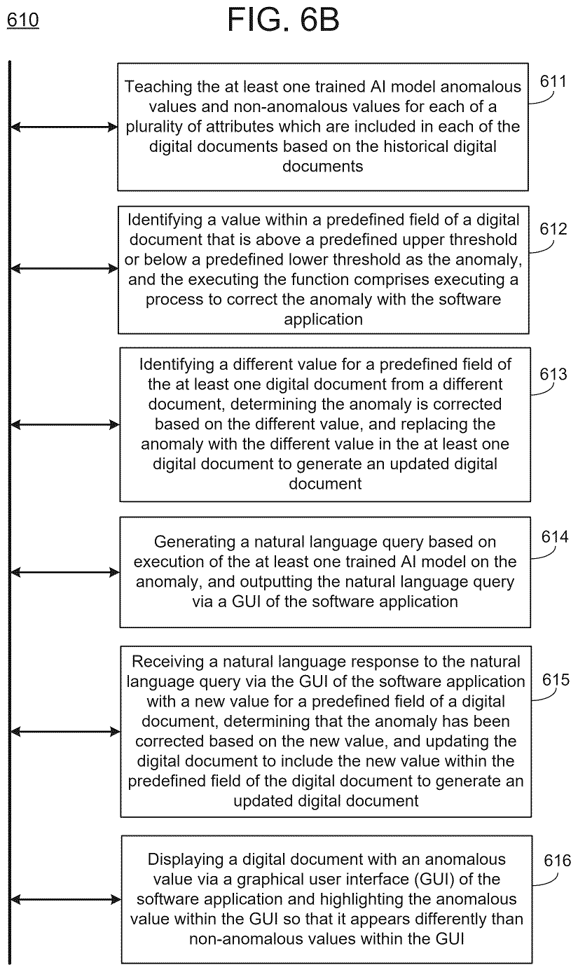

FIG. 6A illustrates a flow diagram of a method 600, according to example embodiments. Referring to FIG. 6A, in 601, the method may include training at least one AI model to identify anomalous values in digital documents based on historical values that are stored in historical digital documents. For example, an iForest model may be trained based on historical anomalous values in historical business form such as a tax form, insurance form, financial statement, or the like. In 602, the method may include receiving a plurality of digital documents with a software application. For example, the digital documents may include tax forms, business forms, statements, or the like. In 603, the method may include identifying at least one digital document among the plurality of digital documents which includes an anomaly based on execution of the at least one trained AI model on the plurality of digital documents. For example, the at least one AI model may identify a value within a field of the at least one digital document that is outside an expected range of values for the field, and is considered an outlier. In 604, the method may include removing the at least one digital document from the plurality of digital documents to generated a reduced set of digital documents. For example, the software may discard the at least one digital document (e.g., transaction data, message, file, etc.) In 605, the method may include executing a second AI model on the reduced set of digital documents to generate a determination. For example, the second AI model may be used to make a decision on whether to approve an action for the user based on the completed forms/digital documents. In 606, the method may include executing a function within the software application based on the determination. The function may include approving/ authorizing an action, modifying a display of a GUI, opening a new profile, opening a new document, outputting content, and the like.

FIG. 6B illustrates a flow diagram of a method 610, according to example embodiments. Referring to FIG. 6B, in 611, the method may include teaching the at least one AI model anomalous values and non-anomalous values for each of a plurality of attributes which are included in each of the digital documents based on the historical digital documents. Here, a table may store the anomalous values and the non-anomalous values, and may include labels as well. The table may be fed to the at least one AI model. In 612, the method may include identifying a value within a predefined field of a digital document that is above a predefined upper threshold or below a predefined lower threshold as the anomaly, and the executing the function comprises executing a process to correct the anomaly with the software application. As an example, a value in a tax form may be less than a minimum threshold or more than a maximum threshold, and may be considered an anomaly.

In 613, the method may include identifying a different document associated with the at least one digital document in a database, identifying a different value for a predefined field of the at least one digital document from the different document, determining the anomaly is corrected based on the different value, and replacing the anomaly with the different value in the predefined field of the at least one digital document to generate an updated digital document. For example, another form, such as a financial statement, may include the correct value for the anomalous value. In 614, the method may include generating a natural language query based on execution of the at least one trained AI model on the anomaly, and outputting the natural language query via a graphical user interface (GUI) of the software application. For example, the at least one trained AI model may query the user for additional information such as the requested value, previous values, and the like.

In 615, the method may include receiving a natural language response to the natural language query via the GUI of the software application with a new value for a predefined field of the digital document, determining that the anomaly has been corrected based on the new value, and updating the digital document to include the new value within the predefined field of the digital document to generate an updated digital document. In this example, the user may provide the correct value by inputting it into a GUI, or the like, and submitting it to the system. In 616, the method may include displaying a digital document with an anomalous value via a graphical user interface (GUI) of the software application and highlighting the anomalous value within the GUI so that it appears differently than non-anomalous values within the GUI. Here, the system may highlight the anomalous value with different colors (e.g., highlighted colors), bold lettering, different backgrounds, shading, and the like.

The methods shown and described with respect to FIGS. 6A and 6B may be performed with a computing system, a software application, a combination thereof, and the like.

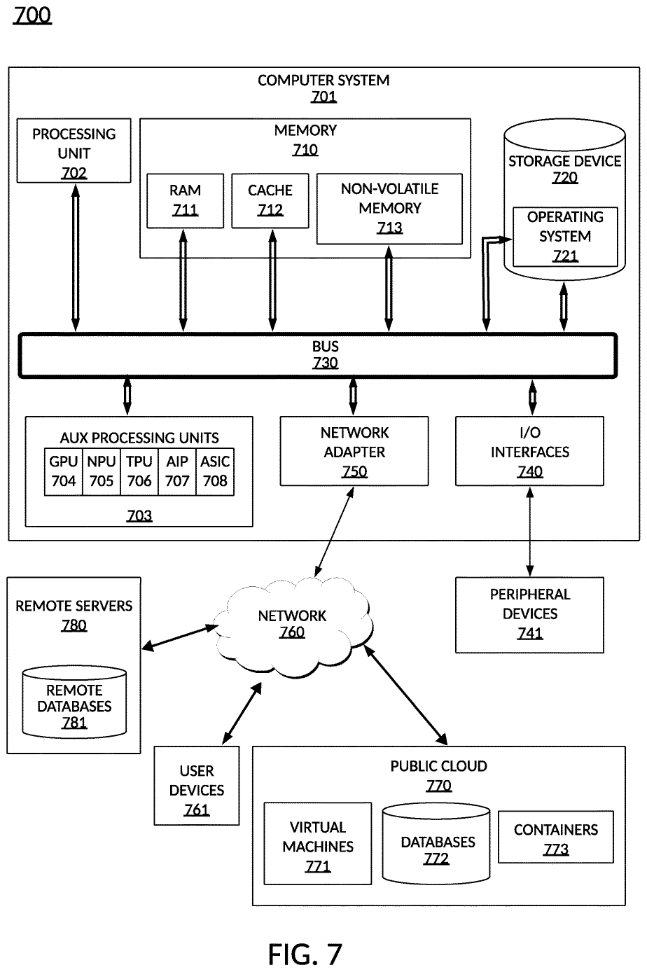

The examples and features of the instant solution may be implemented in at least one of the elements described or depicted herein, including for example, the elements described or depicted in FIG. 7. These examples and features may further be implemented in hardware, in a computer program executed by a processor, in firmware, or in a combination of the above. A computer program may be embodied on a computer readable medium, such as a storage medium. For example, a computer program may reside in random access memory (RAM), flash memory, read-only memory (ROM), erasable programmable read-only memory (EPROM), electrically erasable programmable read-only memory (EEPROM), registers, hard disk, a removable disk, a compact disk read-only memory (CD-ROM), or any other form of storage medium known in the art.

An exemplary storage medium may be communicatively coupled to the processor such that the processor may read information from, and write information to, the storage medium. In the alternative, the storage medium may be integral to the processor. The processor and the storage medium may reside in an application specific integrated circuit (ASIC). In the alternative, the processor and the storage medium may reside as discrete components. For example, FIG. 7 illustrates an example computer system architecture, which may represent or be integrated in any of the above-described components, etc.

FIG. 7 illustrates a computing environment according to the instant solution's example features, structures, or characteristics. FIG. 7 is not intended to suggest any limitation as to the scope of use or functionality of features, structures, or characteristics of the instant solution of the application described herein. Regardless, the computing environment 700 can be implemented to perform any of the functionalities described herein. In computing environment 700, there is a computer system 701, operational within numerous other general-purpose or special-purpose computing system environments or configurations.

Computer system 701 may take the form of a desktop computer, laptop computer, tablet computer, smartphone, smartwatch or other wearable computer, server computer system, thin client, thick client, network computer system, minicomputer system, mainframe computer, quantum computer, and distributed cloud computing environment that include any of the described systems or devices, and the like or any other form of computer or mobile device now known or to be developed in the future that is capable of running a program, accessing a network 760 or querying a database. Depending upon the technology, the performance of a computer-implemented method may be distributed among multiple computers and among multiple locations. However, in this presentation of the computing environment 700, a detailed discussion is focused on a single computer, specifically computer system 701, to keep the presentation as simple as possible.

Computer system 701 may be located in a cloud, even though it is not shown in a cloud in FIG. 7. On the other hand, computer system 701 may not be in a cloud except to any extent as may be affirmatively indicated. Computer system 701 may be described in the general context of computer system-executable instructions, such as program modules, executed by a computer system 701. Generally, program modules may include routines, programs, objects, components, logic, data structures, and so on that perform tasks or implement certain abstract data types. As shown in FIG. 7, computer system 701 in computing environment 700 is shown in the form of a general-purpose computing device. The components of computer system 701 may include but are not limited to, at least one processor or processing unit 702, a system memory 710, and a bus 730 that couples various system components, including system memory 710 to processing unit 702.

Processing unit 702 includes at least one computer processor of any type now known or to be developed. The processing unit 702 may contain circuitry distributed over multiple integrated circuit chips. The processing unit 702 may also implement multiple processor threads and multiple processor cores. Cache 712 is a memory that may be in the processor chip package(s) or located “off-chip,” as depicted in FIG. 7. Cache 712 is typically used for data or code accessed by the threads or cores running on the processing unit 702. In some computing environments, processing unit 702 may be designed to work with qubits and perform quantum computing.

The Auxiliary Processing Units (APU) 703 may contain at least one Graphics Processing Unit (GPU) 704, Neural Processing Unit (NPU) 705, Tensor Processing Unit (TPU) 706, AI Processor (AIP) 707, or other Application Specific Integrated Circuit (ASIC) 708. The at least one APU 703 may contain circuitry distributed over multiple integrated circuit chips. Each APU 703 may implement multiple processor threads and multiple processor cores. Each APU 703 may include at least one of onboard memory, onboard memory cache, and onboard instruction cache. Each APU may be communicatively coupled to the system bus 730 and configure to communicate with other system components, including a processing unit 702, system cache 712, RAM 711, non-volatile RAM 713, operating system 721, Network adapter 750, and Input/Output interfaces 740. In some computing environments, at least one of the at least one APU 703 may be designed to work with qubits and perform quantum computing.

Memory 710 is any volatile memory now known or to be developed in the future. Examples include dynamic random-access memory (RAM) 711 or static type RAM 711. Typically, the volatile memory is characterized by random access, but this may not be the characterization unless affirmatively indicated. In computer system 701, memory 710 is in a single package. It is internal to computer system 701, but alternatively or additionally, the volatile memory may be distributed over multiple packages and/or located externally with respect to computer system 701. By way of example, memory 710 can be provided for reading from and writing to a non-removable, non-volatile magnetic media (shown as storage device 720, and typically called a “hard drive”). Memory 710 may include at least one program product having a set (e.g., at least one) of program modules configured to carry out the functions of various features, structures, or characteristics of the instant solution of the application. A typical computer system 701 may include cache 712, a specialized volatile memory generally faster than RAM 711 and generally located closer to the processing unit 702. Cache 712 stores frequently accessed data and instructions accessed by the processing unit 702 to speed up processing time. The computer system 701 may also include non-volatile memory 713 in the form of ROM, PROM, EEPROM, and flash memory. Non-volatile memory 713 often contains programming instructions for starting the computer, including the basic input/output system (BIOS) and information to start the operating system 721.

Computer system 701 may include a removable/non-removable, volatile/non-volatile computer storage device 720. For example, storage device 720 can be a non-removable, non-volatile magnetic media (not shown and typically called a “hard drive”). At least one data interface can connect it to the bus 730. In features, structures, or characteristics of the instant solution where computer system 701 has a large amount of storage (for example, where computer system 701 locally stores and manages a large database), then this storage may be provided by peripheral storage devices 720 designed for storing very large amounts of data, such as a storage area network (SAN) that is shared by multiple, geographically distributed computers.

The operating system 721 is software that manages computer system 701 hardware resources and provides common services for computer programs. Operating system 721 may take several forms, such as various known proprietary operating systems or open-source Portable Operating System Interface type operating systems that employ a kernel.

The bus 730 represents at least one of several types of bus structures, including a memory bus or memory controller, a peripheral bus, an accelerated graphics port, and a processor or local bus using various bus architectures. By way of example, and not limitation, such architectures include Industry Standard Architecture (ISA) buses, Micro Channel Architecture (MCA) buses, Enhanced ISA (EISA) buses, Video Electronics Standards Association (VESA) local buses, and Peripheral Component Interconnect (PCI) bus. The bus 730 is the signal conduction path that allows the various components of computer system 701 to communicate.

Computer system 701 may communicate with at least one peripheral device, 741, via an input/output (I/O) interface, 740. Such devices may include a keyboard, a pointing device, a display, etc.; at least one device that enables a user to interact with computer system 701; and/or any devices (e.g., network card, modem, etc.) that enable computer system 701 to communicate with at least one other computing devices. Such communication can occur via I/O interface 740. As depicted, I/O interface 740 communicates with the other components of computer system 701 via bus 730.

Network adapter 750 enables the computer system 701 to connect and communicate with at least one network 760, such as a local area network (LAN), a wide area network (WAN), and/or a public network (e.g., the Internet). It bridges the computer's internal bus 730 and the external network, exchanging data efficiently and reliably. The network adapter 750 may include hardware, such as modems or Wi-Fi signal transceivers, and software for packetizing and/or de-packetizing data for communication network transmission. Network adapter 750 supports various communication protocols to ensure compatibility with network standards. Ethernet connections adhere to protocols such as IEEE 802.3, while wireless communications might support IEEE 802.11 standards, Bluetooth, near-field communication (NFC), or other network wireless radio standards.

Network 760 is any computer network that can receive and/or transmit data. Network 760 can include a WAN, LAN, private cloud, or public Internet, capable of communicating computer data over non-local distances by any technology that is now known or to be developed in the future. Any connection depicted can be wired and/or wireless and may traverse other components that are not shown. In some features, structures, or characteristics of the instant solution, a network 760 may be replaced and/or supplemented by LANs designed to communicate data between devices in a local area, such as a Wi-Fi network. The network 760 typically includes computer hardware such as copper transmission cables, optical transmission fibers, wireless transmission, routers, firewalls, switches, gateway computers, edge servers, and network infrastructure known now or to be developed in the future. Computer system 701 connects to network 760 via network adapter 750 and bus 730.

User devices 761 are any computer systems used and controlled by an end user in connection with computer system 701. For example, in a hypothetical case where computer system 701 is designed to provide a recommendation to an end user, this recommendation may typically be communicated from network adapter 750 of computer system 701 through network 760 to a user device 761, allowing user device 761 to display, or otherwise present, the recommendation to an end user. User devices can be a wide array, including personal computers, laptops, tablets, hand-held, mobile phones, etc.

A public cloud 770 is an on-demand availability of computer system resources, including data storage and computing power, without direct active management by the user. Public clouds 770 are often distributed, with data centers in multiple locations for availability and performance. Computing resources on public clouds 770 are shared across multiple tenants through virtual computing environments comprising virtual machines 771, databases 772, containers 773, and other resources. A container 773 is an isolated, lightweight software for running a software application on the host operating system 721. Containers 773 are built on top of the host operating system's kernel and contain software applications and some lightweight operating system APIs and services. In contrast, virtual machine 771 is a software layer with an operating system 721 and kernel. Virtual machines 771 are built on top of a hypervisor emulation layer designed to abstract a host computer's hardware from the operating software environment. Public clouds 770 generally offers databases 772, abstracting high-level database management activities. At least one element described or depicted in FIG. 7 can perform at least one of the actions, functionalities, or features described or depicted herein.

Remote servers 780 are any computers that serve at least some data and/or functionality over a network 760, for example, WAN, a virtual private network (VPN), a private cloud, or via the Internet to computer system 701. These networks 760 may communicate with a LAN to reach users. The user interface may include a web browser or a software application that facilitates communication between the user and remote data. Such software applications have been referred to as “thin” desktop software applications or “thin clients.” Thin clients typically incorporate software programs to emulate desktop sessions. Mobile device software applications can also be used. Remote servers 780 can also host remote databases 781, with the database located on one remote server 780 or distributed across multiple remote servers 780. Remote databases 781 are accessible from database client applications installed locally on the remote server 780, other remote servers 780, user devices 761, or computer system 701 across a network 760. An AI/ML model described or depicted here may reside fully or partially on any of the elements described or depicted in FIG. 7.

Although an exemplary example of the instant solution of at least one of an apparatus, method, and computer readable medium has been illustrated in the accompanying drawings and described in the foregoing detailed description, it will be understood that the instant solution is not limited to the examples of the instant solution disclosed but is capable of numerous rearrangements, modifications, and substitutions as set forth and defined by the following claims. For example, the instant solution's capabilities of the various figures can be performed by at least one of the modules or components described herein or in a distributed architecture and may include a transmitter, receiver, or pair of both. For example, all or part of the functionality performed by the individual modules may be performed by at least one of these modules. Further, the functionality described herein may be performed at various times and in relation to various events, internal or external to the modules or components. Also, the information sent between various modules can be sent between the modules via at least one of a data network, the Internet, a voice network, an Internet Protocol network, a wireless device, a wired device and/or via a plurality of protocols. Also, the messages sent or received by any of the modules may be sent or received directly and/or via at least one of the other modules.

One skilled in the art will appreciate that the instant solution may be embodied as a personal computer, a server, a console, a personal digital assistant (PDA), a cell phone, a tablet computing device, a smartphone, or any other suitable computing device, or combination of devices. Presenting the above-described functions as being performed by the instant solution is not intended to limit the scope of the present instant solution in any way but is intended to provide one example of the many examples of the instant solution. Indeed, methods, systems, and apparatuses disclosed herein may be implemented in localized and distributed forms consistent with computing technology.

It should be noted that some of the instant solution features described in this specification have been presented as modules in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise at least one physical or logical block of computer instructions that may, for instance, be organized as an object, procedure, or function. Nevertheless, the executables of an identified module may not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory, tape, or any other such medium used to store data.

Indeed, a module of executable code may be a single instruction or many instructions and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations, including over different storage devices, and may exist, at least partially, merely as electronic signals on a system or network.

It will be readily understood that the components of the instant solution, as generally described and illustrated in the figures herein, may be arranged and designed in a wide variety of different configurations. Thus, the detailed descriptions of the instant solution and the examples and features of the instant solution are not intended to limit the scope of the instant solution as claimed but are merely representative examples of the instant solution.

One having ordinary skill in the art will readily understand that the above may be practiced with steps in a different order and/or with hardware elements in configurations that are different from those which are disclosed. Therefore, although the instant solution has been described based upon these preferred examples and features of the instant solution, it would be apparent to those of skill in the art that certain modifications, variations, and alternative constructions would be apparent.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

An exemplary storage medium may be coupled to the processor such that the processor may read information from, and write information to, the storage medium. In the alternative, the storage medium may be integral to the processor. The processor and the storage medium may reside in an application-specific integrated circuit (“ASIC”). In the alternative, the processor and the storage medium may reside as discrete components.

1. A method comprising:
receiving a plurality of digital documents with a software application;
identifying a digital document in the plurality of digital documents that includes an anomalous value, based on an artificial intelligence (AI) model being executed on the plurality of digital documents, wherein the Al model is configured to identify anomalous values in digital documents based on historical values in historical digital documents;
removing the digital document from the plurality of digital documents to generate a reduced set of digital documents;
executing a second AI model on the reduced set to generate a determination; and
correcting the anomalous value using the software application based on the determination.

2. The method of claim 1, comprising:
identifying whether each attribute included in the plurality of digital documents is anomalous or non-anomalous using the Al model.

3. The method of claim 1, wherein the anomalous value is a value within a predefined field of the digital document that is above an upper threshold or below a lower threshold.

4. The method of claim 1, wherein the correcting of the anomalous value comprises:
identifying a different document associated with the digital document in a database;
identifying a different value for a predefined field of the digital document from the different document;
determining that the anomalous value will be corrected by the different value; and
replacing the anomalous value with the different value in the predefined field of the digital document to generate an updated digital document.

5. The method of claim 1, wherein the correcting of the anomalous value comprises:
generating a natural language query based on the Al model being executed on the anomalous value; and
outputting the natural language query via a graphical user interface (GUI) of the software application.

6. The method of claim 5, wherein the correcting of the anomalous value further comprises:
receiving a natural language response to the natural language query via the GUI of the software application, wherein the natural language response includes a new value for a predefined field of the digital document;
determining that the anomalous value has been corrected based on the new value; and
updating the digital document to include the new value within the predefined field.

7. The method of claim 1, comprising:
displaying the digital document via a graphical user interface (GUI) of the software application; and
highlighting an attribute of the digital document corresponding to the anomalous value using the GUI.

8. An apparatus comprising:
a processor that executes instructions stored in a memory to configure the processor to:
receive a plurality of digital documents with a software application;
identify a digital document in the plurality of digital documents that includes an anomalous value, based on an artificial intelligence (Al) model being executed on the plurality of digital documents, wherein the Al model is configured to identify anomalous values in digital documents based on historical values in historical digital documents;
remove the digital document from the plurality of digital documents to generate a reduced set of digital documents;
execute a second AI model on the reduced set of digital documents to generate a determination; and
correct the anomalous value using the software application based on the determination.

9. The apparatus of claim 8, wherein the processor is configured to:
identify whether each attribute included in the plurality of digital documents is anomalous or non-anomalous using the Al model.

10. The apparatus of claim 8, wherein the anomalous value is a value within a predefined field of the digital document that is above an upper threshold or below a lower threshold.

11. The apparatus of claim 8, wherein, when the processor corrects the anomalous value, the processor is configured to:
identify a different document associated with the at least one digital document in a database;
identify a different value for a predefined field of the at least one digital document from the different document;
determine that the anomalous value will be corrected by the different value; and
replace the anomalous value with the different value in the predefined field of the digital document to generate an updated digital document.

12. The apparatus of claim 8, wherein, when the processor corrects the anomalous value, the processor is configured to:
generate a natural language query based on the trained Al model being executed on the anomalous value; and
output the natural language query via a graphical user interface (GUI) of the software application.

13. The apparatus of claim 12, wherein, when the processor corrects the anomalous value, the processor is configured to:
receive a natural language response to the natural language query via the GUI of the software application, wherein the natural language response includes a new value for a predefined field of the digital document;
determine that the anomalous value has been corrected based on the new value; and
update the digital document to include the new value within the predefined field.

14. The apparatus of claim 8, wherein the processor is configured to:
display the digital document via a graphical user interface (GUI) of the software application; and
highlight an attribute of the digital document corresponding to the anomalous value using the GUI.

15. A non-transitory computer-readable medium comprising instructions that, when executed by a processor, cause the processor to perform:
receiving a plurality of digital documents with a software application;
identifying a digital document in the plurality of digital documents that includes an anomalous value, based on an artificial intelligence (Al) model being executed on the plurality of digital documents, wherein the Al model is configured to identify anomalous values in digital documents based on historical values in historical digital documents;
removing the digital document from the plurality of digital documents to generate a reduced set of digital documents;
executing a second Al model on the reduced set to generate a determination; and
correcting the anomalous value using the software application based on the determination.

16. The non-transitory computer-readable medium of claim 15, wherein the instructions cause the processor to perform: identifying whether each attribute included in the plurality of digital documents is anomalous or non-anomalous using the AI model.

17. The non-transitory computer-readable medium of claim 15, wherein the anomalous value is a value within a predefined field of the digital document that is above an upper threshold or below a lower threshold.

18. The non-transitory computer-readable medium of claim 15, wherein the correcting of the anomalous value comprises:
identifying a different document associated with the digital document in a database;
identifying a different value for a predefined field of the digital document from the different document;
determining that the anomalous value will be corrected by the different value; and
replacing the anomalous value with the different value in the predefined field of the digital document to generate an updated digital document.

19. The non-transitory computer-readable medium of claim 15, wherein the correcting of the anomalous value comprises:
generating a natural language query based on the AI model being executed on the anomalous value; and
outputting the natural language query via a graphical user interface (GUI) of the software application.

20. The non-transitory computer-readable medium of claim 19, wherein the correcting of the anomalous values further comprises:
receiving a natural language response to the natural language query via the GUI of the software application, wherein the natural language response includes a new value for a predefined field of the digital document;
determining that the anomalous value has been corrected based on the new value; and
updating the digital document to include the new value within the predefined field.
